(19) United States
(12) Patent Application Publication
(10) Pub. No.: US 2026/0117111 A1
(43) Pub. Date: Apr. 30, 2026

(54) CEMENTING SPACER

(71) Applicant: Riteks, Inc., The Woodlands, TX (US)

(72) Inventors: Freddie L. Sabins, Spring, TX (US); Collin M. Berwick, Magnolia, TX (US)

(73) Assignee: Riteks, Inc., The Woodlands, TX (US)

(21) Appl. No.: 19/371,970

(22) Filed: Oct. 28, 2025

Related U.S. Application Data
(60) Provisional application No. 63/713,561, filed on Oct. 29, 2024.

(51) Int. Cl. C09K 8/40; C04B 18/24; C04B 22/00; C04B 22/06; C04B 24/26; C04B 24/38; C04B 28/00; C04B 103/44

(52) U.S. Cl. CPC C09K 8/40; C04B 18/24; C04B 22/0006; C04B 22/06; C04B 24/2611; C04B 24/38; C04B 28/001; C04B 2103/44; C09K 2208/04; C09K 2208/08

(57) ABSTRACT

A fluid spacer formulation includes about 3-9% by weight viscosifying material; about 40-50% by weight bentonite; about 4-16% by weight plant fiber; and about 29-55% by weight sealing agent.

### CROSS REFERENCE TO RELATED APPLICATION

This application claims the benefit of U.S. Provisional Patent Application No. 63/713,561, filed Oct. 29, 2024, the disclosure of which is hereby incorporated herein in its entirety by reference.

### BACKGROUND

A primary cementing treatment is performed once the well has been drilled to a specified depth and a pipe has been run into the well to near the bottom of the hole. Oilwell cement slurry is pumped down the pipe (casing) and into the annulus between the casing and hole. Once in place, the cement slurry hardens to create a seal between the casing and hole. This seal functions to support and stabilize the casing in the hole and to prevent unwanted flow of well fluids through the annulus.

Placement of the cement is complicated by the cement slurry's potential incompatibility with the drilling fluid that fills the wellbore as the cementing process begins. Pumping cement slurry into the well displaces drilling fluid, and complete displacement is a primary factor that influences the success of a cement treatment. Annulus eccentricity can create pockets of static drilling fluid at the narrow side of the annulus. Flow of spacer fluid up the narrow side of the annulus to displace this drilling fluid is inhibited by an increased pressure requirement to move fluid through the narrowed annular gap. Thus, drilling fluid is bypassed and left in the annulus thereby creating an unsealed fluid channel through which unwanted formation fluid can traverse. Also, incompatibility of the cement slurry and drilling fluid when comingled in the annulus results in formation of highly viscous gel at the interface, bypassed drilling fluid, incomplete drilling fluid removal from the borehole and casing, and poor bonding of the set cement to the casing and borehole wall due to residual drilling fluid film remaining on the borehole surfaces.

The detrimental impacts of this bypassed drilling fluid and fluid incompatibility can be at least partially alleviated by interjecting a spacer fluid to separate the drilling fluid from the cement slurry. Common spacer fluids are water based and contain a clay (e.g., bentonite) and viscosifying polymer. The spacer fluid may be further designed to include one or more properties based on the specific needs of the formation. For example, weighted spacer fluids can be designed, e.g., by adding barite to the formulation, to help with well control. Reactive spacer fluids may be designed to help with cement placement and more effectively remove drilling mud. Versatility of the spacer fluid may be increased if rheology can be adjusted to tailor application to specific drilling fluid and cement slurry rheology. Surfactants can be added to the spacer fluid to control mixture gelation or leave surfaces water wettable (especially with oil-based drilling fluids). In any event, the spacer fluid must be compatible (i.e., no drastic gelation caused by fluid intermixing) with both the drilling fluid and the cement slurry.

While various spacer fluid designs have been developed and implemented, it would be useful for a spacer fluid to be designed with improved sealing characteristics that restrict the spacer's permeation into porous formations.

### SUMMARY

The following presents a simplified summary of the invention in order to provide a basic understanding of some aspects of the invention. The summary is not an extensive overview of the invention. It is not intended to identify critical elements of the invention or to delineate the scope of the invention. Its sole purpose is to present some aspects of the invention in a simplified form as a prelude to the more detailed description that is presented elsewhere herein.

A spacer fluid is usually prepared by adding dry components to water. The dry components can be added to the water separately or blended together into a single dry powder blend called a spacer mix. Standardized dry blend containing basic powdered materials (in wt %) required to produce desired basic spacer fluid attributes is referred to as spacer mix. Additional dry or liquid additives in addition to the spacer mix may be incorporated into the spacer fluid to impart properties required for a specific application (e.g. weighting materials or surfactants).

According to an embodiment, a spacer mix formulation includes about 3-9% by weight viscosifying material; about 40-50% by weight bentonite; about 6-16% by weight plant fiber; and about 30-40% by weight sealing agent.

In another embodiment, a spacer mix formulation includes 1-2 parts viscosifying polymer, 4-11 parts bentonite, 1-3 parts plant fiber (e.g., peanut hull and/or oat fiber), and 4-8 parts sealing agent.

According to still another embodiment, a method of forming a spacer fluid comprises mixing 10-20 pounds of a spacer mix formulation with water to form a barrel of the spacer fluid.

### WRITTEN DESCRIPTION

Embodiments of a unique sealing spacer fluid designed to improve the ability of the spacer to help seal the formation are described. Generally, the sealing spacer fluid is an aqueous slurry that includes plant fiber, bentonite, viscosifying material, and optionally weighting material for density control. As is discussed in greater detail herein, by including fumed silica or another sealing agent, the spacer is better able to seal the formation by forming a membrane between the formation and the fluids in the annulus. More specifically, the novel spacer helps to seal a permeable, weak, or fractured formation to prevent loss of fluid flowing in the annulus thereby increasing the equivalent circulating density (ECD) while the well is being circulated. ECD represents the hydraulic pressure a particular formation will support without allowing significant volumes of well fluid into permeability, vugs, or fractures. This metric of formation integrity quantifies maximum fluid density and flow rate values the formation will withstand. Staying below ECD during drilling and completion prevents major losses of drilling fluid or cement slurry thereby improving wellbore integrity, avoiding downtime, and lowering operational cost. The spacer also helps to inhibit loss of filtrate or spacer slurry into the permeable, fractured, or weak formation. Notably, the spacer also exhibits an improved rheology profile and stability compared to other spacer fluids.

The plant fiber may be any plant fiber that is available. Examples of plant fibers include but are not limited to seed fibers, for example, cotton; wood fibers, for example, bamboo; fruit fibers, for example, coconut fibers; leaf fibers, for example, sisal or abaca; and bast fibers, for example, flax, hemp, jute, or kenaf. Other plant fibers that may be used include rice; cereal grains such as oat, wheat, barley, and rye; and seed pods, such as peanut husks.

Traditionally, the plant fiber makes up nearly 50% of the spacer mix. According to the invention, the amount of plant fiber is significantly reduced in comparison to traditional fluid spacers when fumed silica, or another sealing agent, is added to the spacer mix.

Particle size distribution for the plant fiber may range from approximately 150 to 75 microns (corresponding to 100-200 mesh).

The sealing agent may be any material or combination of materials capable of improving the sealing properties of the spacer fluid. For example, the sealing agent may be one or more pyrogenic silicas and/or silica-based additives including but not limited to fumed silica and/or silica flour. In embodiments the sealing agent may be, or include, a manganese tetroxide-based material, such as Micromax®. The sealing agent may also be referred to as a micro particle or micro particle material, including, for example, micro silica. Crumb rubber (120 mesh) may also function as a sealing agent. At least fumed silica, silica flour, and crumb rubber have not heretofore been incorporated into fluid spacers to facilitate sealing the formation by forming a membrane between the formation and the cement casing. Fumed silica may serve as a thickening agent to allow the spacer fluid to exhibit improved sealing performance as compared to prior spacer fluids that incorporate plant fibers alone. As used herein, the terms “fumed silica” and “silica fume” are used interchangeably to refer to an amorphous silicon dioxide powder.

The viscosifying material can be any material capable of altering the viscosity of the spacer fluid, as is known in the art. For example, the viscosifying material may be one or more polysaccharides including but not limited to agar, alginin, carrageenan, xanthan gum, and/or carboxymethyl cellulose. In embodiments, the viscosifying material may be, or include, a protein, such as egg white, collagen, and/or gelatin. The viscosifying material could also be, or include, for example, polyethylene glycol and/or polyacrylic acid. Other viscosifying materials that could be used, either alone or in combination, include polyurethanes, such as polyvinyl alcohol. As used herein, a viscosifying material may also be referred to as a gellant or gel.

The weighting material may similarly be any material that is capable of sufficiently functioning to control the density of the spacer fluid formulation. Exemplary weighting agents may include, but are not limited to, one or more of the following: ilmenite, hematite, manganese tetroxide-based materials such as Micromax®, barite, calcium carbonate, and siderite.

In embodiments, the spacer fluid formulation further includes one or more surfactants. The surfactant(s) may aid in controlling mixture gelation, and may further allow surfaces to be water-wettable, and particularly with oil-based drilling fluids, as is known to those of skill in the art. The surfactant may be any surfactant that is now known or later developed.

According to an embodiment of the invention, the preferred spacer mix formulation includes xanthan as viscosifying polymer, bentonite, oat fiber (or another plant fiber), and silica fume or crumb rubber as a sealing agent. The bentonite is preferably API cement grade.

In aspects, the spacer mix formulation comprises about 3-9% by weight xanthan gum (or other viscosifying polymer), about 40-50% by weight bentonite, about 6-16% by weight oat fiber (or other plant fiber), and about 30-40% by weight silica fume or crumb rubber.

According to another aspect of the invention, the spacer mix formulation comprises about 6-8% by weight xanthan gum (or other viscosifying polymer), about 44-47% by weight bentonite, about 11-16% by weight oat fiber (or another plant fiber), and about 29-39% by weight silica fume or crumb rubber.

According to another aspect of the invention, the spacer mix formulation comprises about 4-8% by weight xanthan (or other viscosifying polymer), about 37-47% by weight bentonite, about 4-9% by weight oat fiber (or other plant fiber), and about 45-55% by weight crumb rubber.

According to another aspect of the invention, the spacer mix formulation comprises about 4-8% by weight xanthan (or other viscosifying polymer), about 43-49% by weight bentonite, about 8-13% by weight oat fiber (or other plant fiber), and about 33-37% by weight silica fume.

In still another aspect of the invention, the spacer mix formulation comprises about 5-7% by weight xanthan (or other viscosifying polymer), about 45-47% by weight bentonite, about 10-12% by weight oat fiber (or other plant fiber), and about 34-36% by weight silica fume.

According to still yet another aspect of the invention, the spacer mix formulation comprises about 6-7% by weight xanthan (or other viscosifying polymer), about 46-47% by weight bentonite, about 11-12% by weight oat fiber (or other plant fiber), and about 34.5-35.5% by weight silica fume.

In a preferred aspect of the invention, the spacer mix formulation comprises about 6.7% by weight xanthan (or other viscosifying polymer), about 46.7% by weight bentonite, about 11.7% by weight oat fiber (or other plant fiber), and about 35% by weight silica fume.

In a more preferred aspect of the invention, the spacer mix formulation comprises about 6.67% by weight xanthan, about 46.67% by weight bentonite, about 11.67% by weight oat fiber, and about 35% by weight silica fume.

In the most preferred aspect of the invention, the spacer mix formulation comprises about 8% by weight xanthan, about 47% by weight bentonite, about 16% oat fiber (or another plant fiber), and about 29% by weight silica fume.

In an embodiment, the spacer mix formulation comprises viscosifying polymer, bentonite, plant fiber, and silica fume. In an aspect, the formulation comprises 1-2 parts viscosifying polymer (e.g., xanthan), 5-10 parts bentonite, 1-3 parts plant fiber (e.g., peanut hull and/or oat fiber), and 3.5-7 parts silica fume or crumb rubber. In a preferred aspect, the formulation comprises 1.5-2.8 parts viscosifying polymer (e.g., xanthan), 5.5-9.5 parts bentonite, 1.5-2.8 parts plant fiber (e.g., peanut hull and/or oat fiber), and 4-7 parts silica fume or crumb rubber. In a more preferred aspect, the formulation comprises 1 part viscosifying polymer (e.g., xanthan), 7 parts bentonite, 1.75 parts plant fiber (e.g., oat fiber), and 5.25 parts silica fume.

In another embodiment, the spacer mix formulation consists of viscosifying polymer, bentonite, plant fiber, and silica fume or crumb rubber. In an aspect, the formulation consists of 1-2 parts viscosifying polymer (e.g., xanthan), 5-10 parts bentonite, 1-3 parts plant fiber (e.g., peanut hull and/or oat fiber), and 3.5-7 parts silica fume or crumb rubber. In a preferred aspect, the formulation consists of 1.5-2.8 parts viscosifying polymer (e.g., xanthan), 5.5-9.5 parts bentonite, 1.5-2.8 parts plant fiber (e.g., peanut hull and/or oat fiber), and 4-7 parts silica fume. In a more preferred aspect, the formulation consists of 1 part viscosifying polymer (e.g., xanthan), 7 parts bentonite, 1.75 parts plant fiber (e.g., oat fiber), and 5.25 parts silica fume.

In still another embodiment, the spacer mix formulation consists essentially of viscosifying polymer, bentonite, plant fiber, and silica fume or crumb rubber. In an aspect, the formulation consists essentially of 1-2 parts viscosifying polymer (e.g., xanthan), 5-10 parts bentonite, 1-3 parts plant fiber (e.g., peanut hull and/or oat fiber), and 3.5-7 parts silica fume. In a preferred aspect, the formulation consists essentially of 1.5-2.8 parts viscosifying polymer (e.g., xanthan), 5.5-9.5 parts bentonite, 1.5-2.8 parts plant fiber (e.g., peanut hull and/or oat fiber), and 4-7 parts silica fume. In a more preferred aspect, the formulation consists essentially of 1 part viscosifying polymer (e.g., xanthan), 7 parts bentonite, 1.75 parts plant fiber (e.g., oat fiber), and 5.25 parts silica fume.

In an embodiment, the spacer mix formulation comprises viscosifying polymer, bentonite, plant fiber, and sealing agent (e.g., silica fume, silica flour, crumb rubber, and/or manganese tetroxide-based material). In an aspect, the formulation comprises about 0.55-2.0 parts viscosifying polymer (e.g., xanthan), about 4.43-10.5 parts bentonite, about 1.07-2.9 parts plant fiber (e.g., peanut hull and/or oat fiber), and about 3.94-7.89 parts sealing agent (e.g., silica fume, silica flour, crumb rubber, and/or manganese tetroxide-based material). In a preferred aspect, the formulation comprises about 1.1-1.4 parts viscosifying polymer (e.g., xanthan), about 6.6-8.5 parts bentonite, about 2.2-2.9 parts plant fiber (e.g. peanut hull and/or oat fiber), and about 4.1-5.2 parts sealing agent (e.g., silica fume, silica flour, crumb rubber, and/or manganese tetroxide-based material). In a more preferred aspect, the formulation comprises about 1.3-1.4 parts viscosifying polymer (e.g., xanthan), about 7.5-8.5 parts bentonite, about 2.6-2.9 parts plant fiber (e.g. peanut hull and/or oat fiber), and about 4.6-5.2 parts sealing agent (e.g., silica fume, silica flour, crumb rubber, and/or manganese tetroxide-based material.). In a still more preferred aspect, the formulation comprises about 1.4 parts viscosifying polymer (e.g., xanthan), about 8.3 parts bentonite, about 2.8 parts plant fiber (e.g. peanut hull and/or oat fiber), and about 5.1 parts sealing agent (e.g., silica fume, silica flour, crumb rubber, and/or manganese tetroxide-based material).

In another embodiment, the spacer mix formulation consists of viscosifying polymer, bentonite, plant fiber, and sealing agent (e.g., silica fume, silica flour, crumb rubber, and/or manganese tetroxide-based material). In an aspect, the formulation consists of about 0.55-2.0 parts viscosifying polymer (e.g., xanthan), about 4.43-10.5 parts bentonite, about 1.07-2.9 parts plant fiber (e.g., peanut hull and/or oat fiber), and about 3.94-7.89 parts sealing agent (e.g., silica fume, silica flour, crumb rubber, and/or manganese tetroxide-based material). In a preferred aspect, the formulation consists of about 1.1-1.4 parts viscosifying polymer (e.g., xanthan), about 6.6-8.5 parts bentonite, about 2.2-2.9 parts plant fiber (e.g. peanut hull and/or oat fiber), and about 4.1-5.2 parts sealing agent (e.g., silica fume, silica flour, crumb rubber, and/or manganese tetroxide-based material). In a more preferred aspect, the formulation consists of about 1.3-1.4 parts viscosifying polymer (e.g., xanthan), about 7.5-8.5 parts bentonite, about 2.6-2.9 parts plant fiber (e.g. peanut hull and/or oat fiber), and about 4.6-5.2 parts sealing agent (e.g., silica fume, silica flour, crumb rubber, and/or manganese tetroxide-based material). In a still more preferred aspect, the formulation consists of about 1.4 parts viscosifying polymer (e.g., xanthan), about 8.3 parts bentonite, about 2.8 parts plant fiber (e.g. peanut hull and/or oat fiber), and about 5.1 parts sealing agent (e.g., silica fume, silica flour, crumb rubber, and/or manganese tetroxide-based material).

In another embodiment, the spacer mix formulation consists essentially of viscosifying polymer, bentonite, plant fiber, and sealing agent (e.g., silica fume, silica flour, crumb rubber, and/or manganese tetroxide-based material). In an aspect, the formulation consists essentially of about 0.55-2.0 parts viscosifying polymer (e.g., xanthan), about 4.43-10.5 parts bentonite, about 1.07-2.9 parts plant fiber (e.g., peanut hull and/or oat fiber), and about 3.94-7.89 parts sealing agent (e.g., silica fume, silica flour, crumb rubber, and/or manganese tetroxide-based material). In a preferred aspect, the formulation consists essentially of about 1.1-1.4 parts viscosifying polymer (e.g., xanthan), about 6.6-8.5 parts bentonite, about 2.2-2.9 parts plant fiber (e.g. peanut hull and/or oat fiber), and about 4.1-5.2 parts sealing agent (e.g., silica fume, silica flour, crumb rubber, and/or manganese tetroxide-based material). In a more preferred aspect, the formulation consists essentially of about 1.3-1.4 parts viscosifying polymer (e.g., xanthan), about 7.5-8.5 parts bentonite, about 2.6-2.9 parts plant fiber (e.g. peanut hull and/or oat fiber), and about 4.6-5.2 parts sealing agent (e.g., silica fume, silica flour, crumb rubber, and/or manganese tetroxide-based material). In a still more preferred aspect, the formulation consists essentially of about 1.4 parts viscosifying polymer (e.g., xanthan), about 8.3 parts bentonite, about 2.8 parts plant fiber (e.g. peanut hull and/or oat fiber), and about 5.1 parts sealing agent (e.g., silica fume, silica flour, crumb rubber, and/or manganese tetroxide-based material).

In an embodiment, the spacer mix formulation comprises viscosifying polymer, bentonite, plant fiber, and silica-based additive (e.g., silica fume and/or silica flour). In an aspect, the formulation comprises about 0.55-2.0 parts viscosifying polymer (e.g., xanthan), about 4.43-10.5 parts bentonite, about 1.07-2.9 parts plant fiber (e.g., peanut hull and/or oat fiber), and about 3.94-7.89 parts silica-based additive (e.g., silica fume and/or silica flour). In a preferred aspect, the formulation comprises about 1.1-1.4 parts viscosifying polymer (e.g., xanthan), about 6.6-8.5 parts bentonite, about 2.2-2.9 parts plant fiber (e.g. peanut hull and/or oat fiber), and about 4.1-5.2 parts silica-based additive (e.g., silica fume and/or silica flour). In a more preferred aspect, the formulation comprises about 1.3-1.4 parts viscosifying polymer (e.g., xanthan), about 7.5-8.5 parts bentonite, about 2.6-2.9 parts plant fiber (e.g. peanut hull and/or oat fiber), and about 4.6-5.2 parts silica-based additive (e.g., silica fume and/or silica flour). In a still more preferred aspect, the formulation comprises about 1.4 parts viscosifying polymer (e.g., xanthan), about 8.3 parts bentonite, about 2.8 parts plant fiber (e.g. peanut hull and/or oat fiber), and about 5.1 parts silica-based additive (e.g., silica fume and/or silica flour).

In another embodiment, the spacer mix formulation consists of viscosifying polymer, bentonite, plant fiber, and silica-based additive (e.g., silica fume and/or silica flour). In an aspect, the formulation consists of about 0.55-2.0 parts viscosifying polymer (e.g., xanthan), about 4.43-10.5 parts bentonite, about 1.07-2.9 parts plant fiber (e.g., peanut hull and/or oat fiber), and about 3.94-7.89 parts silica-based additive (e.g., silica fume and/or silica flour). In a preferred aspect, the formulation consists of about 1.1-1.4 parts viscosifying polymer (e.g., xanthan), about 6.6-8.5 parts bentonite, about 2.2-2.9 parts plant fiber (e.g. peanut hull and/or oat fiber), and about 4.1-5.2 parts silica-based additive (e.g., silica fume and/or silica flour). In a more preferred aspect, the formulation consists of about 1.3-1.4 parts viscosifying polymer (e.g., xanthan), about 7.5-8.5 parts bentonite, about 2.6-2.9 parts plant fiber (e.g. peanut hull and/or oat fiber), and about 4.6-5.2 parts silica-based additive (e.g., silica fume and/or silica flour). In a still more preferred aspect, the formulation consists of about 1.4 parts viscosifying polymer (e.g., xanthan), about 8.3 parts bentonite, about 2.8 parts plant fiber (e.g. peanut hull and/or oat fiber), and about 5.1 parts silica-based additive (e.g., silica fume and/or silica flour).

In another embodiment, the spacer mix formulation consists essentially of viscosifying polymer, bentonite, plant fiber, and silica-based additive (e.g., silica fume and/or silica flour). In an aspect, the formulation consists essentially of about 0.55-2.0 parts viscosifying polymer (e.g., xanthan), about 4.43-10.5 parts bentonite, about 1.07-2.9 parts plant fiber (e.g., peanut hull and/or oat fiber), and about 3.94-7.89 parts silica-based additive (e.g., silica fume and/or silica flour). In a preferred aspect, the formulation consists essentially of about 1.1-1.4 parts viscosifying polymer (e.g., xanthan), about 6.6-8.5 parts bentonite, about 2.2-2.9 parts plant fiber (e.g. peanut hull and/or oat fiber), and about 4.1-5.2 parts silica-based additive (e.g., silica fume and/or silica flour). In a more preferred aspect, the formulation consists essentially of about 1.3-1.4 parts viscosifying polymer (e.g., xanthan), about 7.5-8.5 parts bentonite, about 2.6-2.9 parts plant fiber (e.g. peanut hull and/or oat fiber), and about 4.6-5.2 parts silica-based additive (e.g., silica fume and/or silica flour). In a still more preferred aspect, the formulation consists essentially of about 1.4 parts viscosifying polymer (e.g., xanthan), about 8.3 parts bentonite, about 2.8 parts plant fiber (e.g. peanut hull and/or oat fiber), and about 5.1 parts silica-based additive (e.g., silica fume and/or silica flour).

In an embodiment, the spacer mix formulation comprises viscosifying polymer, bentonite, plant fiber, and silica fume. In an aspect, the formulation comprises about 0.88-2.0 parts viscosifying polymer (e.g., xanthan), about 6.6-10.5 parts bentonite, about 1.71-2.9 parts plant fiber (e.g., peanut hull and/or oat fiber), and about 4.1-7.89 parts silica fume. In a preferred aspect, the formulation comprises about 1.1-1.4 parts viscosifying polymer (e.g., xanthan), about 6.6-8.5 parts bentonite, about 2.2-2.9 parts plant fiber (e.g. peanut hull and/or oat fiber), and about 4.1-5.2 parts silica fume. In a more preferred aspect, the formulation comprises about 1.3-1.4 parts viscosifying polymer (e.g., xanthan), about 7.5-8.5 parts bentonite, about 2.6-2.9 parts plant fiber (e.g. peanut hull and/or oat fiber), and about 4.6-5.2 parts silica fume. In a still more preferred aspect, the formulation comprises about 1.4 parts viscosifying polymer (e.g., xanthan), about 8.3 parts bentonite, about 2.8 parts plant fiber (e.g. peanut hull and/or oat fiber), and about 5.1 parts silica fume.

In an embodiment, the spacer mix formulation consists of viscosifying polymer, bentonite, plant fiber, and silica fume. In an aspect, the formulation consists of about 0.88-2.0 parts viscosifying polymer (e.g., xanthan), about 6.6-10.5 parts bentonite, about 1.71-2.9 parts plant fiber (e.g., peanut hull and/or oat fiber), and about 4.1-7.89 parts silica fume. In a preferred aspect, the formulation consists of about 1.1-1.4 parts viscosifying polymer (e.g., xanthan), about 6.6-8.5 parts bentonite, about 2.2-2.9 parts plant fiber (e.g. peanut hull and/or oat fiber), and about 4.1-5.2 parts silica fume. In a more preferred aspect, the formulation consists of about 1.3-1.4 parts viscosifying polymer (e.g., xanthan), about 7.5-8.5 parts bentonite, about 2.6-2.9 parts plant fiber (e.g. peanut hull and/or oat fiber), and about 4.6-5.2 parts silica fume. In a still more preferred aspect, the formulation consists of about 1.4 parts viscosifying polymer (e.g., xanthan), about 8.3 parts bentonite, about 2.8 parts plant fiber (e.g. peanut hull and/or oat fiber), and about 5.1 parts silica fume.

In an embodiment, the spacer mix formulation consists essentially of viscosifying polymer, bentonite, plant fiber, and silica fume. In an aspect, the formulation consists essentially of about 0.88-2.0 parts viscosifying polymer (e.g., xanthan), about 6.6-10.5 parts bentonite, about 1.71-2.9 parts plant fiber (e.g., peanut hull and/or oat fiber), and about 4.1-7.89 parts silica fume. In a preferred aspect, the formulation consists essentially of about 1.1-1.4 parts viscosifying polymer (e.g., xanthan), about 6.6-8.5 parts bentonite, about 2.2-2.9 parts plant fiber (e.g. peanut hull and/or oat fiber), and about 4.1-5.2 parts silica fume. In a more preferred aspect, the formulation consists essentially of about 1.3-1.4 parts viscosifying polymer (e.g., xanthan), about 7.5-8.5 parts bentonite, about 2.6-2.9 parts plant fiber (e.g. peanut hull and/or oat fiber), and about 4.6-5.2 parts silica fume. In a still more preferred aspect, the formulation consists essentially of about 1.4 parts viscosifying polymer (e.g., xanthan), about 8.3 parts bentonite, about 2.8 parts plant fiber (e.g. peanut hull and/or oat fiber), and about 5.1 parts silica fume.

Descriptions of examples of components that may be used to formulate the various spacer mixes and that have been evaluated appear in the following table:

| | | Particle size/ |
|---|---|---|
| Material | Description | Descriptor |
| Oat Fiber | Vegetable Fiber | |
| Peanut Fiber | Vegetable Fiber | |
| Bentonite | Montmorillonite clay | variable |
| Xanthan Gum | Viscosifying polymer | NA |
| 325 Silica Flour | Crystalline Silicon | 44 microns average |
| | Dioxide | |
| Micro Fume | Amorphous Silicon | 150 nano meters |
| 102 DM | Oxide Powder | average |
| Micromax ® | Manganese Tetroxide | 1 to 10 microns |
| Crumb Rubber | Ground Tires | 120 mesh |

The spacer mix formulation is mixed with water to prepare the spacer fluid. The spacer mix may be combined in a concentration of about 10-20 pounds of spacer mix formulation per barrel of aqueous fluid. For 10 pounds of spacer mix formulation, approximately 41 gallons of aqueous fluid may be mixed with the formulation. For 20 pounds of spacer mix formulation, about 40.8 gallons of water may be added.

In an embodiment, the spacer mix formulation is mixed with water at a specified concentration of the spacer mix formulation per barrel. In an aspect, the spacer mix formulation is mixed with water at a concentration of about 10-20 pounds of the spacer mix formulation per barrel. In a preferred aspect, the spacer mix formulation is mixed with water at a concentration of about 14-18 pounds of the spacer mix formulation per barrel. In a more preferred aspect, the spacer mix formulation is mixed with water at a concentration of about 16-18 pounds of the spacer mix formulation per barrel. In a still more preferred aspect, the spacer mix formulation is mixed with water at a concentration of about 17.75 pounds of the spacer mix formulation per barrel.

The effectiveness of the sealing spacer may be examined using a sealing test. The performance improvements recognized by the novel spacer design are notable and surprising. To test the sealing effectiveness, the spacer fluid is deposited on top of a water-saturated 20-40 sand bed contained in the bottom portion of a cylindrical pressure vessel. The pressure vessel is equipped with heaters for elevated temperature testing as well as with ports and valves on the top and bottom end caps. Differential pressure is applied to the spacer fluid trough the top end cap, and the filtrate that passes into the sand bed is measured over a 30 minute period. Differential pressure may be either 100 psi or 1000 psi. The lower differential pressure is used for screening initial spacer mix design formulations while performance measured using higher differential pressure is the criterion for performance evaluation.

The step-by-step effluent rate test procedure includes the following steps:
1. Place 450.75 g of 100 mesh sand in static cell.
2. Weigh and blend sealing spacer.
3. Place sealing spacer in atmospheric consistometer to condition to temperature.
4. After placing spacer to condition, place 120 ml of water in the 450.75 g sand bed

in the static cell.
5. Once water is placed in the sand bed, place 100 cc graduated cylinder under bottom stem and open stem. After ten minutes, record volume of water in graduated cylinder.
6. Close bottom stem, place top cap on static cell to prevent evaporation.
7. After conditioning, pour sealing spacer on top of sand bed, filling to ¼″ from top of top screen.
8. Assemble static cell to perform testing.
9. Attach pressure line to top stem.
10. Open top stem, bottom stem, top valve, and start timer.
11. Record “spurt”. Spurt is classified as the stream of fluid flowing from bottom stem into graduated cylinder. Record fluid volume and time interval over which the spurt loss occurs.
12. Continue test for the remaining 30 minutes. Record the volume of effluent collected in the graduated cylinder every five minutes. Effluent rate is the average rate of fluid collected (cc/min) over the last 15 minutes of the test.

The rate of fluid exiting the cylinder or the effluent rate determines the effectiveness of the seal created by the fluid spacer. If the effluent rate is less than about 0.5 cc/minute, the sealing effectiveness is considered very excellent. If the effluent rate is less than about 0.75 cc/minute, the sealing effectiveness is considered excellent. At less than 1.0 cc/minute effluent rate, the effectiveness is considered good. Anything over 1 cc/minute effluent rate is considered a poor seal. Effluent rates of spacer fluids without sealing characteristics are sufficiently high to deplete the fluid prior to the end of the 30 minute test period. The effluent rate of such fluids is deemed a “blow out”.

### EXAMPLES

The first three examples described herein illustrate the sealing performance of spacer mix formulations containing either plant fiber or sealing agent, and synergistic effects in sealing performance delivered by combining plant fiber with sealing agent.

### Example 1

A first example illustrates the sealing performance of a sealing spacer fluid without added sealing agent. According to the first example, a spacer mix formulation contained peanut hull fiber, bentonite, and gellant, without any sealing agent. The spacer mix formulation comprised approximately 47 wt % peanut hull fibers, approximately 47 wt % bentonite, and approximately 6 wt % xanthan. The spacer mix was mixed with water at a concentration of about 12 pounds per barrel of spacer fluid (approximately 5.6 lb peanut hull fiber, approximately 5.6 lb bentonite, and approximately 0.7 lb xanthan per barrel of spacer fluid) and was weighted with barite to a density of approximately 12.5 pounds per gallon. The spacer fluid was heated to approximately 150° F. and deposited on top of a 100 mesh sand bed. A 1000 psi differential pressure was applied to the spacer fluid, and effluent was measured for approximately 30 minutes. The spacer fluid exhibited excellent sealing capabilities, with an effluent rate measured at approximately 0.73 cc/min.

### Example 2

A second example illustrates the sealing performance of a sealing spacer fluid without added plant fiber. According to the second example, a spacer mix formulation contained silica fume, bentonite, and gellant, without any plant fiber. The spacer mix formulation comprised approximately 57.9 wt % silica fume, approximately 36.8 wt % bentonite, and approximately 5.3 wt % xanthan. The spacer mix was mixed with water at a concentration of about 19 pounds per barrel of spacer fluid (approximately 11.0 lb silica fume, approximately 7.0 lb bentonite, and approximately 1 lb xanthan per barrel of spacer fluid). This spacer fluid was not weighted. The spacer fluid was heated to approximately 150° F. and deposited on top of a 100 mesh sand bed. A 1000 psi differential pressure was applied to the spacer fluid, and effluent was measured for approximately 30 minutes. The spacer fluid exhibited no sealing effects with the test blowing out prior to the 30 minute mark.

### Example 3

According to a third example, a spacer mix formulation with both plant fiber and sealing agent comprised approximately 13 wt % peanut hull fibers, approximately 33 wt % silica fume, approximately 47 wt % bentonite, and approximately 7 wt % xanthan. The spacer mix was mixed with water at a concentration of about 12 pounds per barrel of spacer fluid (approximately 1.6 lb peanut hull fiber, approximately 4 lb silica fume, approximately 5.6 lb bentonite, and approximately 0.8 lb xanthan per barrel of spacer fluid) and weighted with barite to a density of approximately 12.5 pounds per gallon. The spacer fluid was heated to approximately 150° F. and deposited on top of a 100 mesh sand bed. A 100 psi differential pressure was applied to the spacer fluid, and effluent rate was measured for approximately 30 minutes. The spacer fluid exhibited very excellent sealing capabilities, with an effluent rate measured at approximately 0.33 cc/min. Next, a 1000 psi differential pressure was applied to the spacer fluid, and effluent was measured for approximately 30 minutes. The spacer fluid again exhibited very excellent sealing capabilities, with an effluent rate measured at approximately 0.33 cc/min.

### Example 4

According to a fourth example, a spacer mix formulation comprised approximately 13 wt % oat fiber, approximately 33 wt % silica fume, approximately 47 wt % bentonite, and approximately 7 wt % xanthan. The spacer mix was mixed with water at a concentration of about 12 pounds per barrel of spacer fluid (approximately 1.6 lb oat fiber, approximately 4.0 lb silica fume, approximately 5.6 lb bentonite, and approximately 0.8 lb xanthan per barrel of spacer fluid) and was weighted with a weighting agent to a density of approximately 12 pounds per gallon. The spacer fluid was heated to approximately 150° F. and deposited on top of a 100 mesh sand bed. A 100 psi differential pressure was applied to the spacer fluid, and effluent rate was measured for approximately 30 minutes. The spacer fluid exhibited very excellent sealing capabilities, with an effluent rate measured at approximately 0.47 cc/min. A second sealing test run at 1000 psi differential pressure also exhibited very excellent sealing capabilities with an effluent rate of approximately 0.47 cc/min.

Results of these tests illustrate the synergistic sealing performance delivered by a combination of plant fiber and sealing particles compared to that of plant fiber or sealing agent alone.

The next examples illustrate the range of plant fiber material, sealing agents, and/or spacer mix loading on sealing performance.

### Example 5

In a fifth example, a spacer mix formulation comprised approximately 13 wt % peanut hull fibers, approximately 33 wt % silica fume, approximately 47 wt % bentonite, and approximately 7 wt % xanthan. The spacer fluid was not weighted with a weighting agent. The spacer mix was mixed with water at a concentration of about 15 pounds per barrel of spacer fluid (approximately 1.9 lb peanut hull fiber, approximately 5.0 lb silica fume, approximately 7.0 lb bentonite, and approximately 1.1 lb xanthan per barrel of spacer fluid). The spacer fluid was heated to approximately 150° F. and deposited on top of a 100 mesh sand bed. A 100 psi differential pressure was applied to the spacer fluid, and effluent rate was measured for approximately 30 minutes. The spacer fluid exhibited very excellent sealing capabilities, with an effluent rate measured at approximately 0.27 cc/min. A 1000 psi differential pressure was applied to the spacer fluid, and effluent rate was measured for approximately 30 minutes. The spacer fluid again exhibited very excellent sealing capabilities with an effluent rate measurement of approximately 0.27 cc/min.

### Example 6

According to a sixth example, a spacer mix formulation included approximately 13 wt % oat fibers, approximately 33 wt % silica fume, approximately 47 wt % bentonite, and approximately 7 wt % xanthan. Unlike example 4, the spacer fluid of example 6 was not weighted with a weighting agent. The spacer mix was mixed with water at a concentration of about 12 pounds per barrel of spacer fluid (approximately 1.6 lb oat fibers, approximately 4.0 lb silica fume, approximately 5.6 lb bentonite and approximately 0.8 lb xanthan per barrel of spacer fluid). The sixth spacer fluid was heated to approximately 150° F. and deposited on top of a 100 mesh sand bed. A 100 psi differential pressure was applied to the spacer fluid, and the effluent rate was measured for approximately 30 minutes. The spacer fluid exhibited very excellent sealing capabilities, with an effluent rate measured at approximately 0.2 cc/min. In a second test of this spacer mix formulation, 1000 psi differential pressure was applied to the spacer fluid, and effluent rate was measured for approximately 30 minutes. The spacer fluid again exhibited very excellent sealing capabilities with an effluent rate measurement of approximately 0.33 cc/min.

### Example 7

In a seventh example, a spacer mix formulation included approximately 13.5 wt % oat fiber, approximately 33.5 wt % silica fume, approximately 46.5 wt % bentonite, and approximately 6.5 wt % xanthan. The spacer fluid was not weighted with a weighting agent. The spacer mix was mixed with water at a concentration of about 20 pounds per barrel of spacer fluid (approximately 2.7 lb oat fiber, approximately 6.7 lb silica fume, approximately 9.3 lb bentonite, and approximately 1.3 lb xanthan per barrel of spacer fluid). The spacer fluid was heated to approximately 150° F. and deposited on top of a 100 mesh sand bed. A 100 psi differential pressure was applied to the spacer fluid, and effluent was measured for approximately 30 minutes. The spacer fluid exhibited very excellent sealing capabilities, with an effluent rate measured at approximately 0.27 cc/min. An additional test was performed in which 1000 psi differential pressure was applied to the spacer fluid, and effluent rate was measured for approximately 30 minutes. The spacer fluid again exhibited very excellent sealing capabilities with an effluent rate measurement of approximately 0.2 cc/min.

### Example 8

In an eighth example, a spacer mix formulation included approximately 13.5 wt % oat fiber, approximately 33.5 wt % silica fume, approximately 46.5 wt % bentonite, and approximately 6.5 wt % xanthan. The spacer fluid made from this formulation was not weighted with a weighting agent. The spacer mix was mixed with water at a concentration of about 25 pounds per barrel of spacer fluid (approximately 3.4 lb oat fiber, approximately 8.4 lb silica fume, approximately 11.6 lb gel, and approximately 1.6 lb xanthan per barrel of spacer fluid). The spacer fluid was heated to approximately 150° F. and deposited on top of a 100 mesh sand bed. A 100 psi differential pressure was applied to the spacer fluid, and effluent rate was measured for approximately 30 minutes. The spacer fluid exhibited very excellent sealing capabilities, with an effluent rate measured at approximately 0.2 cc/min. An additional test was performed in which 1000 psi differential pressure was applied to the spacer fluid, and the effluent rate was measured for approximately 30 minutes. The spacer fluid again exhibited very excellent sealing capabilities with an effluent rate measurement of approximately 0.27 cc/min.

### Example 9

In a nineth example, a spacer mix formulation included approximately 16 wt % peanut hull fibers, approximately 29 wt % silica fume, approximately 47 wt % gel, and approximately 8 wt % xanthan. The spacer fluid made from this formulation was not weighted with a weighting agent. The spacer mix was mixed with water at a concentration of about 17.75 pounds per barrel of spacer fluid (approximately 2.83 lb peanut hull fibers, approximately 5.2 lb silica fume, approximately 8.3 lb bentonite, and approximately 1.42 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities with an effluent rate measured at approximately 0.4 cc/min.

### Example 10

In a tenth example, a spacer mix formulation included approximately 16 wt % oat fiber, approximately 29 wt % silica fume, approximately 47 wt % bentonite, and approximately 8 wt % xanthan. The spacer fluid was not weighted with a weighting agent. The spacer mix was mixed with water at a concentration of about 17.75 pounds per barrel of spacer fluid. The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities with an effluent rate measured at approximately 0.33 cc/min.

### Example 11

In an eleventh example, a spacer mix formulation included approximately 11 wt % peanut hull fiber, approximately 39 wt % silica fume, approximately 44 wt % bentonite, and approximately 6 wt % xanthan. The spacer fluid was not weighted with a weighting agent. The spacer mix was mixed with water at a concentration of about 18 pounds per barrel of spacer fluid. The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities with an effluent rate measured at approximately 0.47 cc/min.

### Example 12

In a twelfth example, spacer mix formulation included approximately 16 wt % peanut hull fiber, approximately 29 wt % silica fume, approximately 47 wt % bentonite, and approximately 8 wt % xanthan. The spacer fluid was not weighted with a weighting agent. The spacer mix was mixed with water at a concentration of about 16 per barrel of spacer fluid. The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited poor sealing capabilities, with blow out occurring prior to the end of the 30 minute test period.

### Example 13

In a thirteenth example, spacer mix formulation included approximately 16 wt % oat fiber, approximately 29 wt % silica fume, approximately 47 wt % bentonite, and approximately 8 wt % xanthan. The spacer fluid was not weighted with a weighting agent. The spacer mix was mixed with water at a concentration of about 12 pounds per barrel of spacer fluid (approximately 1.9 lb oat fiber, approximately 3.5 lb silica fume, approximately 5.6 lb bentonite, and approximately 1.0 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited poor sealing capabilities, with blow out occurring prior to the end of the 30 minute test period.

### Example 14

In a fourteenth example, a spacer mix formulation included approximately 16.0 wt % oat fiber, approximately 29.0 wt % silica fume, approximately 47.0 wt % bentonite, and approximately 8.0 wt % xanthan. The spacer fluid was not weighted with a weighting agent. The spacer mix was mixed with water at a concentration of about 14 pounds per barrel of spacer fluid (approximately 2.2 lb oat fiber, approximately 4.1 lb silica fume, approximately 6.6 lb bentonite, and approximately 1.1 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited excellent sealing capabilities, with an effluent rate measured at approximately 0.67 cc/min.

### Example 15

In a fifteenth example, a spacer mix formulation included approximately 11 wt % peanut hull fiber, approximately 39 wt % silica fume, approximately 44 wt % bentonite, and approximately 6 wt % xanthan. The spacer fluid was not weighted with a weighting agent. The spacer mix was mixed with water at a concentration of about 14 pounds per barrel of spacer fluid. The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited poor sealing capabilities with blow out occurring prior to the end of the test period.

### Example 16

In a sixteenth example, a spacer mix formulation included approximately 11 wt % peanut hull fiber, approximately 39 wt % silica fume, approximately 44 wt % bentonite, and approximately 6 wt % xanthan. The spacer fluid was not weighted with a weighting agent. The spacer mix was mixed with water at a concentration of about 16 pounds per barrel of spacer fluid (approximately 1.8 lb peanut hull fiber, approximately 6.2 lb silica fume, approximately 7.0 lb bentonite, and approximately 1.0 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited excellent sealing capabilities with an effluent rate measured at approximately 0.6 cc/min.

### Example 17

In a seventeenth example, a spacer mix formulation included approximately 11 wt % peanut hull fiber, approximately 39 wt % silica fume, approximately 44 wt % bentonite, and approximately 6 wt % xanthan. The spacer fluid was not weighted with a weighting agent. The spacer mix was mixed with water at a concentration of about 18 pounds per barrel of spacer fluid (approximately 2.0 lb peanut hull fibers, approximately 7.0 lb silica fume, approximately 7.9 lb bentonite, and approximately 1.1 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities with an effluent rate measured at approximately 0.47 cc/min.

### Example 18

In an eighteenth example, a spacer mix formulation included approximately 16 wt % peanut hull fiber, approximately 29 wt % silica fume, approximately 47 wt % bentonite, and approximately 8 wt % xanthan. The spacer fluid was not weighted with a weighting agent. The spacer mix was mixed with water at a concentration of about 14 pounds per barrel of spacer fluid (approximately 2.2 lb peanut hull fiber, approximately 4.1 lb silica fume, approximately 6.6 lb bentonite, and approximately 1.1 lb xanthan per barrel of spacer). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited poor sealing capabilities with blow out occurring prior to the end of the test period.

### Example 19

In a nineteenth example, a spacer mix formulation included approximately 15 wt % peanut hull fiber, approximately 28 wt % silica fume, approximately 45 wt % bentonite, and approximately 12 wt % xanthan. The spacer fluid was not weighted with a weighting agent. The spacer mix was mixed with water at a concentration of about 14.5 pounds per barrel of spacer fluid (approximately 2.2 lb peanut hull fibers, approximately 4.1 lb silica fume, approximately 6.5 lb bentonite, and approximately 1.7 lb xanthan per barrel of spacer). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities with an effluent rate measured at approximately 0.33 cc/min.

### Example 20

In a twentieth example, a spacer mix formulation included approximately 15 wt % peanut hull fiber, approximately 28 wt % silica fume, approximately 45 wt % bentonite, and approximately 12 wt % xanthan. The spacer fluid was not weighted with a weighting agent. The spacer mix was mixed with water at a concentration of about 16.7 pounds per barrel of spacer fluid (approximately 2.5 lb peanut hull fibers, approximately 4.7 lb silica fume, approximately 7.5 lb bentonite, and approximately 2.0 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities with an effluent rate measured at approximately 0.47 cc/min.

### Example 21

In a twenty-first example, a spacer mix included approximately 16 wt % peanut hull fiber, approximately 29 wt % silica fume, approximately 47 wt % bentonite, and approximately 8 wt % xanthan. The spacer fluid was not weighted with a weighting agent. The spacer mix was mixed with water at a concentration of about 16 pounds per barrel of space fluid (approximately 2.6 lb peanut hull fibers, approximately 4.6 lb silica fume, approximately 7.5 lb bentonite, and approximately 1.3 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited poor sealing capabilities with blow out occurring prior to the end of the test period.

### Example 22

In a twenty-second example, a spacer mix formulation included approximately 14 wt % peanut hull fiber, approximately 24 wt % silica fume, approximately 55 wt % bentonite, and approximately 7 wt % xanthan. The spacer fluid was not weighted with a weighting agent. The spacer mix was mixed with water at a concentration of approximately 19 pounds per barrel of the spacer fluid (approximately 2.6 lb peanut hull fiber, approximately 4.6 lb silica fume, approximately 10.5 lb bentonite, and approximately 1.3 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities with an effluent rate measured at approximately 0.4 cc/min.

### Example 23

In a twenty-third example, a spacer mix formulation included approximately 14 wt % peanut hull fiber, approximately 26 wt % silica fume, approximately 53 wt % bentonite, and approximately 7 wt % xanthan. The spacer fluid was not weighted with a weighting agent. The spacer mix was mixed with water at a concentration of about 15.5 pounds per barrel of the spacer fluid (approximately 2.2 lb peanut fiber hulls, approximately 4.0 lb silica fume, approximately 8.2 lb bentonite, and approximately 1.1 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities with an effluent rate measured at approximately 0.4 cc/min.

### Example 24

In a twenty-fourth example, a spacer mix formulation included approximately 11 wt % peanut hull fiber, approximately 39 wt % 325-mesh silica flour, approximately 44 wt % bentonite, and approximately 6 wt % xanthan. The spacer fluid was not weighted with a weighting agent. The spacer mix was mixed with water at a concentration of about 10 pounds per barrel of spacer fluid (approximately 1.3 lb peanut hull fiber, approximately 3.9 lb silica flour, approximately 4.4 lb bentonite, and approximately 0.6 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited excellent sealing capabilities, with an effluent rate measured at approximately 0.6 cc/min.

### Example 25

In a twenty-fifth example, a spacer mix formulation included approximately 11 wt % peanut hull fiber, approximately 39 wt % 325-mesh silica flour, approximately 44 wt % bentonite, and approximately 6 wt % xanthan. The spacer fluid was not weighted with a weighting agent. The spacer mix was mixed with water at a concentration of about 12 pounds per barrel of spacer fluid (approximately 1.3 lb peanut hull fiber, approximately 4.7 lb silica flour, approximately 5.3 lb bentonite, and approximately 0.7 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities, with an effluent rate measured at approximately 0.33 cc/min.

### Example 26

In a twenty-sixth example, a spacer mix formulation included approximately 11 wt % peanut hull fiber, approximately 39 wt % 325-mesh silica flour, approximately 44 wt % bentonite, and approximately 6 wt % xanthan. The spacer fluid was not weighted with a weighting agent. The spacer mix was mixed with water at a concentration of about 14 pounds per barrel of spacer fluid (approximately 1.5 lb peanut hull fiber, approximately 5.5 lb silica flour, approximately 6.2 lb bentonite, and approximately 0.8 lb xanthan per barrel of spacer). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities, with an effluent rate measured at approximately 0.47 cc/min.

### Example 27

In a twenty-seventh example, a spacer mix formulation included approximately 11 wt % peanut hull fiber, approximately 39 wt % 325-mesh silica flour, approximately 44 wt % bentonite, and approximately 6 wt % xanthan. The spacer fluid was not weighted with a weighting agent. The spacer mix was mixed with water at a concentration of about 17.75 pounds per barrel of spacer fluid (approximately 2.0 lb peanut hull fiber, approximately 6.9 lb silica flour, approximately 7.81 lb bentonite, and approximately 1.05 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities, with an effluent rate measured at approximately 0.33 cc/min.

### Example 28

In a twenty-eighth example, a spacer mix formulation included approximately 11 wt % peanut hull fibers, approximately 39 wt % Micromax®, approximately 44 wt % bentonite, and approximately 6 wt % xanthan. The spacer fluid was not weighted with a weighting agent. The spacer mix was mixed with water at a concentration of about 12 pounds per barrel of spacer fluid (approximately 1.3 lb peanut hull fibers, approximately 4.7 lb Micromax®, approximately 5.3 lb bentonite, and approximately 7 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities, with an effluent rate measured at approximately 0.33 cc/min.

### Example 29

In a twenty-nineth example, a spacer mix formulation included approximately 11 wt % peanut hull fibers, approximately 39 wt % Micromax®, approximately 44 wt % bentonite, and approximately 6 wt % xanthan. The spacer fluid was not weighted with a weighting agent. The spacer mix was mixed with water at a concentration of about 17.75 pounds per barrel of spacer fluid (approximately 1.95 lb peanut hull fibers, approximately 6.9 lb Micromax®, approximately 7.8 lb bentonite, and approximately 1.1 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities, with a fluid loss measured at approximately 0.40 cc/min.

### Example 30

In a thirtieth example, a spacer mix formulation included approximately 11 wt % peanut hull fibers, approximately 39 wt % Micromax®, approximately 44 wt % bentonite, and approximately 6 wt % xanthan. The spacer fluid was not weighted with a weighting agent. The spacer mix was mixed with water at a concentration of about 18 pounds per barrel of spacer fluid (approximately 2.0 lb peanut hull fibers, approximately 7.0 lb Micromax®, approximately 7.9 lb bentonite, and approximately 1.1 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities, with a fluid loss measured at approximately 0.33 cc/min.

### Example 31

In a thirty-first example, a spacer mix formulation included approximately 11 wt % peanut hull fibers, approximately 39 wt % 120-mesh crumb rubber, approximately 44 wt % bentonite, and approximately 6 wt % xanthan. The spacer fluid was not weighted with a weighting agent. The spacer mix was mixed with water at a concentration of about 10 pounds per barrel of spacer fluid (approximately 1.1 lb peanut hull fibers, approximately 3.9 lb crumb rubber, approximately 4.4 lb bentonite, and approximately 0.6 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities, with an effluent rate measured at approximately 0.4 cc/min.

### Example 32

In a thirty-second example, a spacer mix formulation included approximately 11 wt % peanut hull fibers, approximately 39 wt % 120-mesh crumb rubber, approximately 44 wt % bentonite, and approximately 6 wt % xanthan. The spacer fluid was not weighted with a weighting agent. The spacer mix was mixed with water at a concentration of about 14 pounds per barrel of spacer fluid (approximately 1.5 lb peanut hull fibers, approximately 5.5 lb crumb rubber, approximately 6.2 lb bentonite, and approximately 0.8 lb xanthan) per barrel of spacer fluid. The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities, with an effluent rate measured at approximately 0.33 cc/min.

### Example 33

In a thirty-third example, a spacer mix formulation included approximately 11 wt % peanut hull fibers, approximately 39 wt % 120-mesh crumb rubber, approximately 44 wt % bentonite, and approximately 6 wt % xanthan. The spacer fluid was not weighted with a weighting agent. The spacer mix was mixed with water at a concentration of approximately 17.75 pounds per barrel of spacer fluid (approximately 1.95 lb peanut hull fibers, approximately 6.9 lb crumb rubber, approximately 7.8 lb bentonite, and approximately 1.1 lb xanthan per barrel of spacer fluid). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited very excellent sealing capabilities, with an effluent rate measured at approximately 0.2 cc/min.

### Example 34

In a thirty-fourth example, a spacer mix formulation included approximately 11 wt % peanut hull fibers, approximately 39 wt % 60-mesh crumb rubber, approximately 44 wt % bentonite, and approximately 6 wt % xanthan. The spacer fluid was not weighted with a weighting agent. The spacer mix was mixed with water at a concentration of approximately 14 pounds per barrel of spacer fluid (approximately 1.5 lb peanut hull fibers, approximately 5.5 lb crumb rubber, approximately 6.2 lb bentonite, and approximately 0.8 lb xanthan per barrel of spacer). The spacer fluid was heated to approximately 150° F. and deposited on top of a 100 mesh sand bed. A 1000 psi differential pressure was applied to the spacer fluid, and effluent rate was measured for approximately 30 minutes. The spacer fluid exhibited poor sealing capabilities, with blow out occurring prior to the end of the 30 minute test period.

### Example 35

According to a thirty-fifth example, a spacer mix formulation contained crumb rubber, bentonite, and gellant with plant fiber. The spacer mix formulation included approximately 5 wt % oat fibers, approximately 46 wt % crumb rubber, approximately 44 wt % bentonite, and approximately 5 wt % xanthan. The spacer fluid was not weighted with a weighting agent. The spacer mix was mixed with water at a concentration of approximately 10 pounds per barrel of spacer fluid (approximately 0.5 lb oat fiber, approximately 4.6 lb crumb rubber, approximately 4.4 lb bentonite, and approximately 0.5 lb xanthan per barrel of spacer). The spacer fluid was heated to approximately 150° F. and deposited on top of a 100 mesh sand bed. A 1000 psi differential pressure was applied to the spacer fluid, and effluent was measured for approximately 30 minutes, The spacer fluid exhibited very excellent sealing capabilities, with an effluent rate measured at approximately 0.4 cc/min.

### Observations

Prior spacer mix formulations required that the plant fiber be present in high quantities, with a formulation consisting of 7 parts plant fiber to 7 parts bentonite to 1 part viscosifying polymer. The spacer mix formulations described herein significantly reduce the amount of plant fibers required in the formation by 50 to 75% by weight. Surprisingly, significantly reducing the amount of plant fibers and replacing with silica fume has little effect on the sealing effectiveness of the resulting spacer fluid as compared to spacer fluids with plant fiber alone. Moreover, it was shown that there is little difference between using peanut hull fibers as compared to oat fibers. It was also shown that silica fume, 325-mesh silica flour, Micromax®, and crumb rubber performed similarly as sealing agents. This unexpected performance is significant because the performance capabilities of the inventive spacer mix formulations are maintained while considerably reducing the cost of producing the spacer fluid. Moreover, the versatility of the inventive spacer mix formulation means that there is the potential for wide applicability.

In summary, an inventive fluid spacer formulation described herein provides very excellent sealing capabilities with a combination of vegetable fiber (e.g., peanut hull fiber and/or oat fiber), micro silica or crumb rubber, bentonite clay, and viscosifying polymer in the ratios (by weight) of 16%, 29%, 47%, and 8%, respectively. At 16% weighted loading of vegetable fiber, both peanut hull fiber and the oat fiber provide very excellent sealing capabilities. In embodiments having a spacer mix mixed with water at a concentration of approximately 17 pounds of the spacer mix per barrel of spacer fluid, very excellent sealing capabilities are provided. Decreasing vegetable fiber (e.g., peanut hull fiber and/or oat fiber) to 11 weight % in a spacer mix formulation, and the micro silica, bentonite clay, and viscosifying polymer to weighted loadings of 39%, 44%, and 6%, respectively, requires increasing a concentration to approximately 18 pounds of the spacer mix per barrel of spacer fluid to provide very excellent sealing capabilities. Micro particles or micro fine particles of silica fume, silica flour, and Micromax® are acceptable to use as sealing agents in a spacer mix and provide very excellent sealing capabilities. Crumb rubber (120 mesh) as a sealing agent in the spacer mix also provides very excellent sealing capabilities. Increasing a bentonite clay concentration and/or a xanthan gum concentration in a spacer mix provides increased sealing capabilities.

Many different arrangements of the various components depicted, as well as components not shown, are possible without departing from the spirit and scope of the invention. Embodiments of the invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the invention. It will be understood that certain features and subcombinations are of utility and may be employed without reference to other features and subcombinations.

What is claimed is:

1. A spacer mix formulation, comprising about 3-9% by weight viscosifying material; about 40-50% by weight bentonite; about 4-16% by weight plant fiber; and about 29-55% by weight sealing agent.

2. The spacer mix formulation of claim 1, wherein the formulation comprises about 6-8% by weight viscosifying material; about 44-47% by weight bentonite; about 11-16% by weight plant fiber; and about 29-39% by weight sealing agent.

3. The spacer mix formulation of claim 2, wherein the formulation comprises about 8% by weight viscosifying material; about 47% by weight bentonite; about 16% by weight plant fiber; and about 29% by weight sealing agent.

4. The spacer mix formulation of claim 2, wherein the formulation comprises about 6% by weight viscosifying material; about 44% by weight bentonite, about 11% by weight plant fiber; and about 39% by weight sealing agent.

5. The spacer mix formulation of claim 1, wherein the viscosifying material is one or more materials selected from the list consisting of: agar, alginin, carrageenan, xanthan gum, carboxymethyl cellulose, egg white, collagen, gelatin, polyethylene glycol, polyacrylic acid, and polyvinyl alcohol.

6. The spacer mix formulation of claim 5, wherein the viscosifying material is xanthan gum.

7. The spacer mix formulation of claim 1, wherein the plant fiber is one or more plant fibers selected from the list consisting of cotton, bamboo, coconut, sisal, abaca, flax, hemp, jute, kenaf, rice, oat, wheat, barley, rye, and peanut husk.

8. The spacer mix formulation of claim 7, wherein the plant fiber is peanut husk and/or oat.

9. The spacer mix formulation of claim 1, wherein the sealing agent is one or more sealing agents selected from the list of consisting of silica fume, silica flour, crumb rubber and a manganese tetroxide-based material.

10. The spacer mix formulation of claim 9, wherein the sealing agent is silica fume and/or crumb rubber.

11. The spacer mix formulation of claim 1, wherein the formulation is mixed with water at a concentration of between about 10-20 pounds of formulation per barrel of fluid to form a spacer fluid.

12. The spacer mix formulation of claim 11, wherein the formulation is mixed with water at a concentration of about 17.75 pounds of formulation per barrel of fluid to form the spacer fluid.

13. The spacer mix formulation of claim 1, wherein the formulation comprises about 4-8% by weight viscosifying material; about 37-47% by weight bentonite; about 4-9% by weight plant fiber; and about 45-55% by weight crumb rubber.

14. A spacer mix formulation, comprising 1-2 parts viscosifying polymer, 4-11 parts bentonite, 1-3 parts plant fiber (e.g., peanut hull and/or oat fiber), and 4-8 parts sealing agent.

15. The spacer mix formulation of claim 14, comprising 1.1-1.4 parts viscosifying polymer, 6.6-8.5 parts bentonite, 2.2-2.9 parts plant fiber (e.g., peanut hull and/or oat fiber), and 4.1-5.2 parts sealing agent.

16. The spacer mix formulation of claim 15, comprising 1.4 part viscosifying polymer, 8.3 parts bentonite, 2.8 parts plant fiber (e.g., peanut hull and/or oat fiber), and 5.1 parts sealing agent.

17. The spacer mix formulation of claim 14, wherein the sealing agent is one or more sealing agents selected from the list of consisting of silica fume, silica flour, crumb rubber and a manganese tetroxide-based material.

18. A method of forming a spacer fluid comprising mixing 10-20 pounds of a spacer mix formulation of claim 1 with water to form a barrel of the spacer fluid.

19. The method of forming the spacer fluid of claim 18, further comprising mixing 14-18 pounds of the spacer mix formulation with water to form the barrel of the spacer fluid.

20. The method of forming the spacer fluid of claim 18, further comprising mixing 17.75 pounds of the spacer mix formulation with water to form the barrel of the spacer fluid.
